(19) United States
(12) Patent Application Publication
(10) Pub. No.: US 2017/0008436 A1
(43) Pub. Date: Jan. 12, 2017

(54) Self Aligning Clip Trench For A Foam Pad

(71) Applicant: Magna Seating Inc, Aurora (CA)

(72) Inventor: Daniel C. Wyatt, St. Clair Shores, MI (US)

(21) Appl. No.: 15/200,191

(22) Filed: Jul. 1, 2016

Related U.S. Application Data
(60) Provisional application No. 62/187,522, filed on Jul. 1, 2015.

(51) Int. Cl. B60N 2/58

(52) U.S. Cl. CPC B60N 2/5825; B60N 2/5891

(57) ABSTRACT

A foam mold rail (100) for use with a foam mold tool in forming a foam pad (140) of a seat and a method of mounting a trim cover (150) to the foam pad (140) wherein the foam mold rail (100) is configured to retain a plurality of mechanical clips (122) both vertically and axially with respect to the foam mold rail (100) while simultaneously forming a self-aligning clip trench (138, 238) in the foam pad (140) during the foam pad forming process.

### CROSS-REFERENCE TO RELATED APPLICATIONS

This application claims priority to U.S. Provisional Application No. 62/187,522, filed on Jul. 1, 2015 and entitled “Self Aligning Clip Trench For A Foam Pad.”

### BACKGROUND OF THE INVENTION

### 1. Field of the Invention

The present invention relates to an assembly for attaching and securing a vehicle seat trim cover to a vehicle seat foam pad. More particularly, the present invention relates to a self-aligning clip trench for attaching the trim cover to the foam pad of the vehicle seat.

### 2. Description of Related Art

Vehicle seats typically include a seat back and a seat cushion. The seat back and seat cushion each include a frame for supporting a cellular, foam pad, and a trim cover which at least partially covers the foam pad. A variety of conventional attachment methods, including but not limited to hog-rings, hook and loop, and mechanical clips, are currently used to attach the trim cover to the foam pad. A common problem with each of the aforementioned conventional attachment methods, as well as many of the other well-known methods, is ergonomic assembly. An operator typically has to manually guide an attachment feature disposed on an underside of the trim cover to engage a corresponding attachment feature located on the foam pad.

For Example, FIG. 1 details the well-known method of attaching a trim cover 10 to a foam pad 12 using hog-rings 14. The [hog-ring] method includes providing a number of preformed wires 16 attached to portions 12a of the foam pad 12 where small rings or hooks, dubbed hog-rings 14 in the industry, are crimped to fixedly attach the trim cover 10 to the foam pad 12. During installation, an installer uses a tool to assist with engaging the hog-rings 14 with the preformed wires 16 wherein the hog-rings 14 can thereafter be crimped in place to attach the trim cover 10 to the foam pad 12. Connecting the hog-rings 14 to the preformed wires 16 is ergonomically difficult and requires substantial effort by the installer. Additionally, the hog-ring method does not include the use of an alignment mechanism to ensure proper positioning of the trim cover 10 with the preformed wires 16.

FIG. 2 details another well-known method of attaching a trim cover 20 to a foam pad 22 involving the use of hook and loop fasteners 24. The hook and loop fasteners 24 include a strip of material including hook portions 28 and a strip of material including loop portions 26. The strip of material including the loop portions 26 is mounted to the trim cover 20 and the strip of material including the hook portions 28 is mounted to a corresponding area of the foam pad 22. During installation, the loop portions 26 are overlaid upon the hook portions 28 wherein they engage to secure the trim cover 20 to the foam pad 22. However, hook and loop fasteners 24 are expensive; can become detached from each other over extended periods of use; and do not include an alignment mechanism, which causes the hook and loop fasteners 24 to be more prone to misalignment.

FIG. 3 details yet another well-known method of attaching a trim cover 30 to a foam pad 32 involving the use of mechanical clips 34. The mechanical clips 34 include a pair of spaced apart legs 36 that extend outwardly from a base 38 to form a cavity 40 therebetween. The legs 36 include a pair of upper hooks or barbs 42 that face toward each other, thereby defining a funnel 44 which leads into a cavity 40. The trim cover 30 includes a bead 46 attached thereto. Legs 36 are spaced such that the bead 46 can pass therebetween, becoming entrapped in the cavity 40 by the hooks or barbs 42, which prevents outward movement of the bead 46 from the cavity 40. However, the mechanical clip 34 does not include an alignment mechanism. During assembly, this quite often results in the bead 46 being misaligned and positioned incorrectly between the mechanical clip 34 and a trench 48 formed in the foam pad 32. The trench 48 is formed during the process of molding the mechanical clips 34 into the foam pad 32, which is further detailed below.

FIG. 4 details a known process of embedding the mechanical clip 34 into the foam pad 32. During this process, a foam mold tool (partially shown) is used to form the foam pad 32 and embed the mechanical clip 34 therein. The foam mold tool includes a first mold portion (not shown) and a second mold portion 50. The second mold portion 50 includes a contoured projection 52 having openings 54 formed therealong. The openings 54 are disposed to receive the pair of legs 36 of the mechanical clips 34. Liquid foam material is poured into the foam mold tool and expands about the contoured projection 52 of the second mold portion 50 thereby embedding the mechanical clip 34 into the foam pad 32 being formed. As the liquid foam material is poured into the second mold portion 50 and expanded about the contoured projection 52 in forming the foam pad 32, a trench 48, in the shape of the contoured projection 52, is formed into the foam pad 32. The trench 48 creates a cumbersome and unfortunate potential for the bead 46 to become misaligned with the foam pad 32 during assembly of the trim cover 30 to the foam pad 32. Many times, the person performing the assembly is unaware of such a misalignment which results in the trim cover 30 either becoming detached from the foam pad 32 or the trim cover 30 simply not being fully taught with the foam pad 32.

There are numerous methods and systems which attempt, with varying degrees of success, to address misalignment of the trim cover with the foam pad during automobile seat assembly. The exemplary embodiments detailed herein addresses the issues associated with the previous methods by providing a fail-proof method of aligning and securely attaching a trim cover to a foam pad, as detailed herein below.

### SUMMARY OF THE INVENTION

An exemplary embodiment includes a method for embedding a mechanical clip into a foam pad of a seat and for creating a self-aligning clip trench in the foam pad. The exemplary method involves placement of the mechanical clip in a foam mold tool which is used in the molding process of the foam pad. A foam mold rail herein constitutes only one portion of the foam mold tool (partially shown). Other portions of the foam mold tool are eliminated for simplicity. The exemplary foam mold rail is configured to form the self-aligning clip trench, wherein the geometry of the self-aligning clip trench ensures the proper placement of a trim cover with respect to the foam pad.

The foam mold rail may be integrally formed within one piece of a traditional two-piece foam mold tool (not shown). Alternatively, the foam mold rail may serve as a third piece or as an insert that is inserted within the traditional two-piece foam mold tool for forming a foam pad. The foam mold rail includes a pedestal and a trench forming section. The trench forming section is contoured to form a shaped trench in the foam pad and further includes a plurality of notches spaced intermittently along a tip thereof and a plurality of slots similarly spaced intermittently along opposing sides thereof. The notches and slots are designed to locate a plurality of mechanical clips used to fasten the trim cover to the foam pad. The notches and slots also further assist with aligning the mechanical clips both vertically and axially along the length of the trench forming section thereby ensuring that the mechanical clips used to retain an attachment feature of the trim cover is maintained in position during pouring and expansion of a liquid foam material into the foam mold tool and during the overall molding process.

During assembly of the trim cover with the foam pad, the exemplary self-aligning clip trench that is formed in the foam pad advantageously self-aligns the trim cover with respect to the mechanical clips which are now positioned in the foam pad. As such, any previously known concerns are alleviated with respect to the attachment feature of the trim cover being mistakenly positioned in a space between the foam pad trench and the legs of the mechanical clips, or with respect to the trim cover being misaligned in any manner with the mechanical clips or the foam pad during seat assembly.

### BRIEF DESCRIPTION OF THE DRAWINGS

Advantages of the present disclosure will be readily appreciated as the same becomes better understood by reference to the following detailed description when considered in connection with the accompanying drawings wherein:

FIG. 1 is a perspective view of a conventional method of attaching a trim cover to a foam pad wherein the method involves hog-rings;

FIG. 2 is a perspective view of another conventional method of attaching a trim cover to a foam pad wherein the method involves hook and loop fasteners;

FIG. 3 is a cross-sectional view of yet another conventional method of attaching a trim cover to a foam pad wherein the method involves mechanical clips;

FIG. 4 is a perspective view of the mechanical clip and a portion of a mold used in the conventional method of attaching the trim cover to the foam pad;

FIG. 5 is a perspective view of an exemplary foam mold rail according to one aspect of the invention;

FIG. 6 is a perspective view of the foam mold rail of FIG. 5 with a mechanical clip attached thereto prior to the molding process;

FIG. 7 is a cross-sectional view of a self-aligning clip trench formed in a foam pad after the molding process wherein the mechanical clip is embedded therein;

FIG. 8 is a cross-sectional view detailing the method of placing the trim cover with respect to the self-aligning clip trench formed in the foam pad as shown in FIG. 7;

FIG. 9A is a cross-sectional view detailing the self-aligning feature of the self-aligning clip trench method; and

FIG. 9B is a cross-sectional view of an alternative self-aligning clip trench formed in a foam pad after the molding process wherein the exemplary mechanical clip is embedded therein.

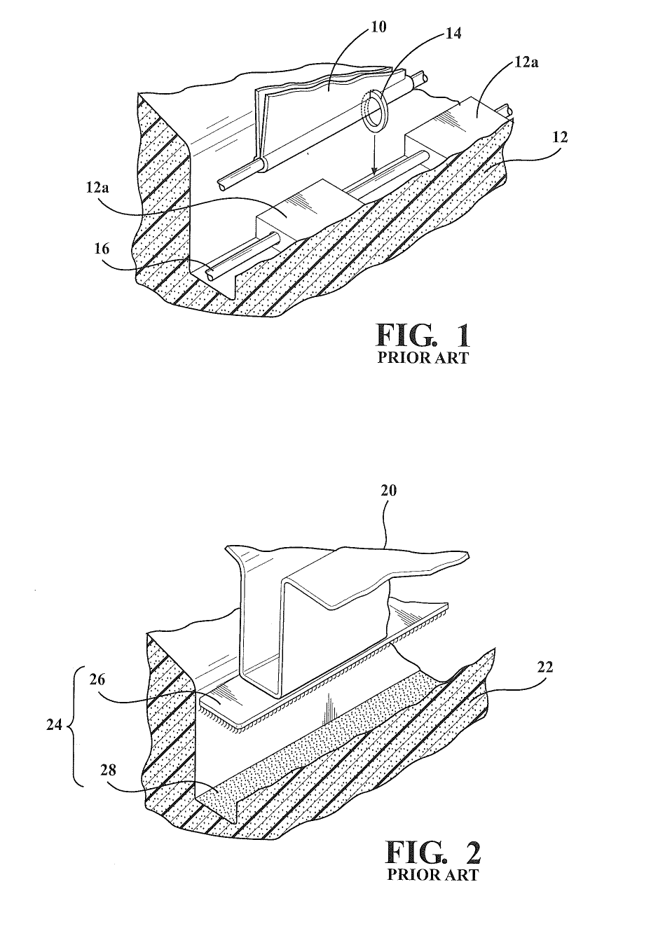

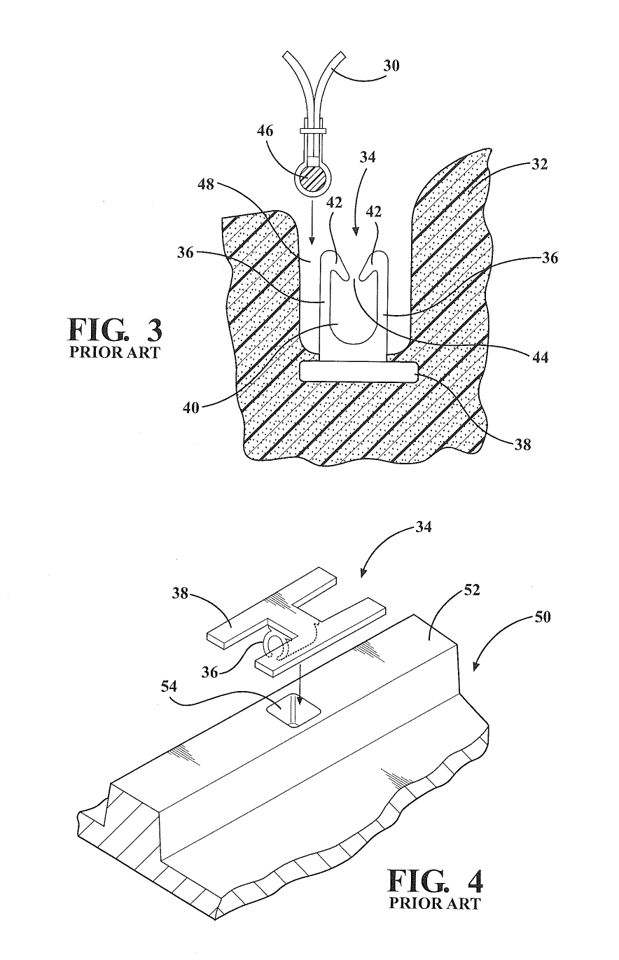

### DETAILED DESCRIPTION OF THE PREFERRED EMBODIMENTS

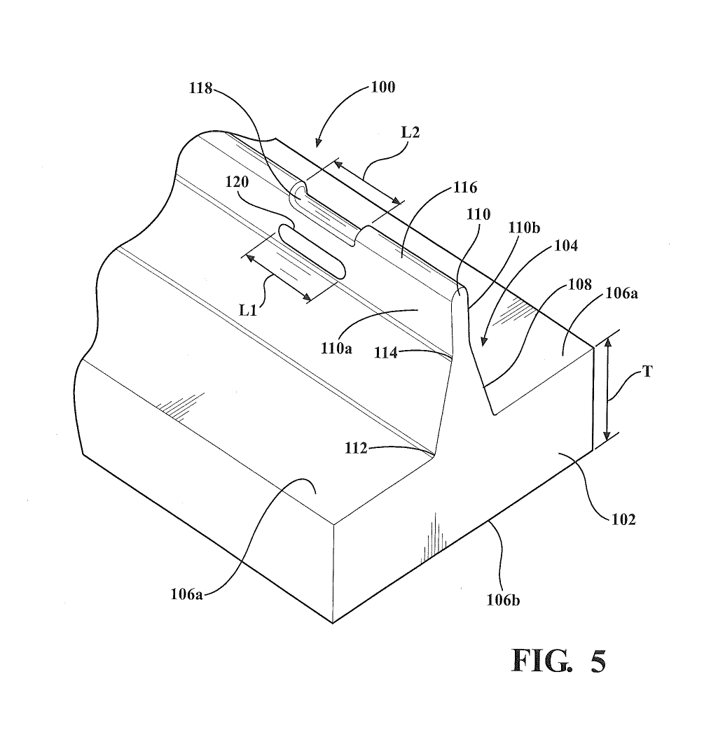

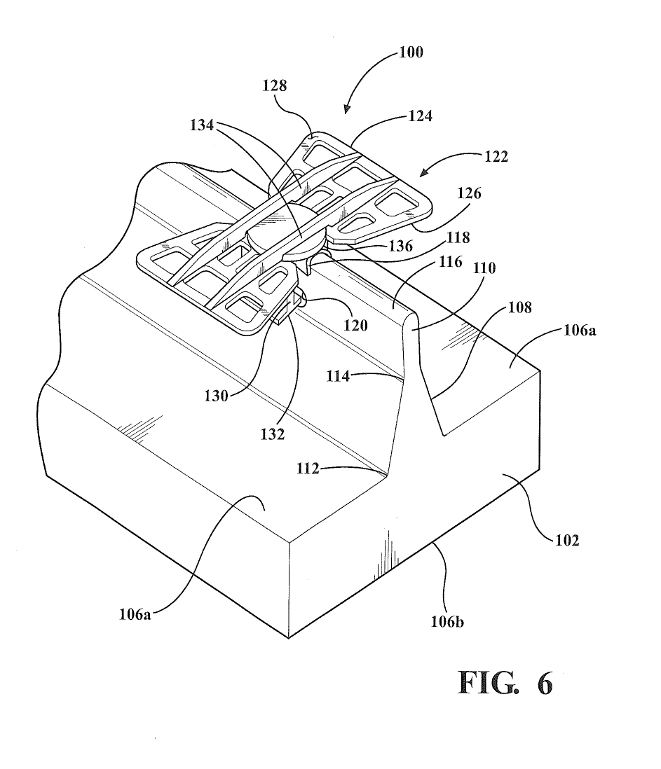

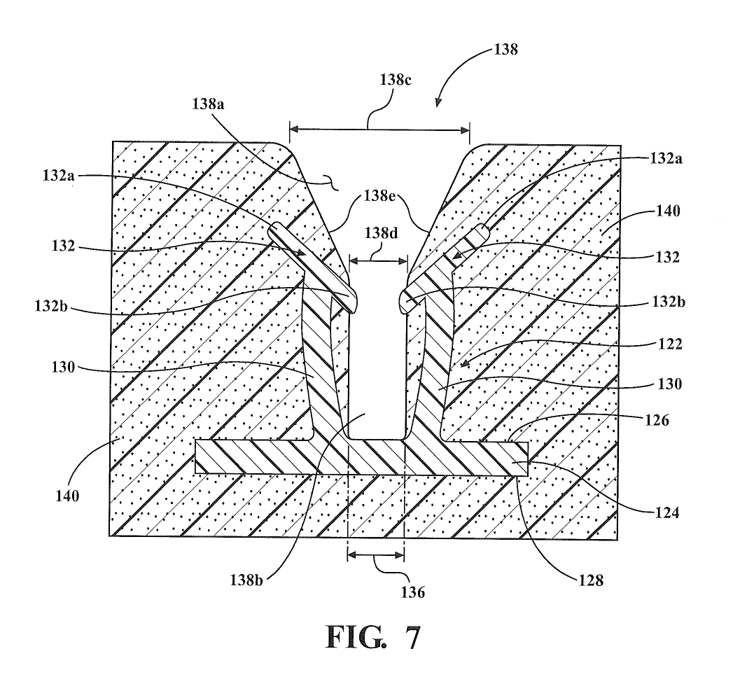

Referring to FIGS. 5 and 6, an exemplary embodiment of a foam mold rail 100 includes a pedestal 102 and a trench forming section 104. The pedestal 102 has an upper surface 106a and a lower surface 106b defining a predetermined thickness T therebetween. If the foam mold rail 100 is integrally formed within one piece of a traditional two-piece foam mold tool, then upper surface 106a would coincide with the A-surface of the foam mold tool. The trench forming section 104 is positioned along the pedestal 102 and extends perpendicularly with respect to the pedestal 102, outwardly away from the upper surface 106a of the pedestal 102. The trench forming section 104 is contoured to include a funnel shaping segment 108 and a trench segment 110. The upper surface 106a of the pedestal 102 extends outwardly away from the trench forming section 104 on opposing sides thereof. The funnel shaping segment 108 includes a widened end 112 and a narrowed end 114. The widened end 112 is connected to the upper surface 106a of the pedestal 102. The funnel shaping segment 108 tapers linearly from the widened end 112 towards the narrowed end 114 in a direction away from the upper surface 106a of the pedestal 102. The trench segment 110 is connected to the narrowed end 114 of the funnel shaping segment 108. The trench segment 110 includes a distal tip 116 wherein the tip 116 includes a plurality of spaced notches 118 formed therealong. The notches 118 are disposed longitudinally along the trench segment 110 and are designed to locate a plurality of mechanical clips 122 used to fasten a trim cover 150 to a foam pad 140, as further described below. The trench segment 110 further includes elongated slots 120 formed in opposing sides 110a, 110b of the trench segment 110. The slots 120 are formed longitudinally about the opposing sides 110a, 110b of the trench segment 110, and are located directly below the notches 118 formed in the tip 116. The slots 120 generally have a length L1 that need not correspond to a length L2 of the notches 118. The notches 118, in combination with the slots 120, assist with aligning the mechanical clips 122 to ensure that the mechanical clips 122 are retained in position both vertically and axially along the length of the trench forming section 104 during the foam pad 140 forming process.

Regarding FIGS. 6 and 7, the mechanical clips 122 include a base 124 having a top surface 126 and a bottom surface 128. A pair of legs 130 is connected to and extends from the top surface 126 of the base 124. The notches 118 and slots 120 have widths and lengths that are predetermined so that the mechanical clips 122 may be securely positioned on the trench forming section 104. The base 124 may include ribs 134 which provide additional strength to the base 124 during the molding process and during general use of the mechanical clips 122 while disposed in the seat. When positioning the clips 122 upon the trench forming section 104, the legs 130 of the mechanical clips 122 straddle the tip 116 of the trench forming section 104 such that a mid-section 136 is positioned within the notches 118. With the legs 130 already straddling the trench segment 110, and just prior to positioning the mid-section 136 of the base 124 within the notch 118, the pair of legs 130 are slid into the respective slots 120 disposed on opposing sides 110a, 110b of the trench segment 110. The pair of legs 130 includes retaining members 132 connected to the legs 130 wherein the retaining members 132 are configured to extend at an angle with respect to the legs 130. Retaining members 132 further assist with retaining the legs 130 within the slots 120 and include a first end 132a and a second end 132b. The second end 132b is retained in the slot 120 of the trench segment 110.

During the molding process, the foam mold rail 100, which is integrally formed within one piece of a traditional two-piece foam mold tool, contains the attached mechanical clips 122 and is joined with the other piece of the foam mold tool (not shown). In another aspect, the foam mold rail 100 may serve as a third piece or as an insert for the two-piece foam mold tool. Once the foam mold rail 100, with the mechanical clips 122 secured thereto, is joined to form the foam mold tool, liquid foam material or other similar expandable material is poured into the mold. The foam mold rail 100 allows for the plurality of mechanical clips 122 to be embedded in the foam pad 140 while simultaneously forming a self-aligning clip trench 138 in the foam pad 140. The mechanical clips 122 may be formed from a polymer material that may be particularly suited to provide good adhesion and chemical reaction bonding with the foam pad 140. Acceptable polymer materials for the mechanical clips 122 include, but are not limited to, nylon, polyester, polycarbonate, polyacetate or any other durable thermoplastic having desired mechanical properties. The foam pads 140 are typically polyurethane or isocyanate-based foam. The material of either the mechanical clips 122 or the foam pad 140 must be selected so as to have the capability of surviving temperature and environmental variations over an expected range, as well as to have the capability of promoting bonding and/or adhesion to one another. As the foam or other similar material expands, it disperses and spreads about the foam mold tool to fully encompass the foam mold rail 100 and the attached mechanical clips 122. In doing so, the first end 132a of the retaining members 132 becomes embedded within the foam pad 140 while the second end 132b of the retaining members 132 is exposed and projects, untampered by the foam or other similar material, into the self-aligning clip trench 138 formed by the trench forming section 104.

In reference to FIG. 7, once the expanded foam or other similar material is set and cured, the foam pad 140 is removed from the foam mold tool and the self-aligning clip trench 138 is formed, thereby exposing the second ends 132b of the retaining members 132. The foam pad 140 is made with the exemplary self-aligning clip trench 138 and mechanical clips 122 molded therein. The self-aligning clip trench 138 includes a funnel 138a that corresponds with the funnel shaping segment 108 and a trench 138b that corresponds with the trench segment 110. The funnel 138a tapers and includes linear side walls 138e that extend from a widened opening 138c of the funnel 138 to a narrowed opening 138d. The trench 138b is continuous in length and width, and extends from the narrowed opening 138d of the self-aligning clip trench 138 to the upper surface 126 of the base 124 of the mechanical clip 122. The second ends 132b project into the self-aligning clip trench 138 at about an intersection of the side walls 138e and the narrowed opening 138d wherein the angled orientation of side walls 138e of the funnel 138a and the projecting second end 132b of the retaining member 132, assist in permitting the self-alignment of the trim cover 150.

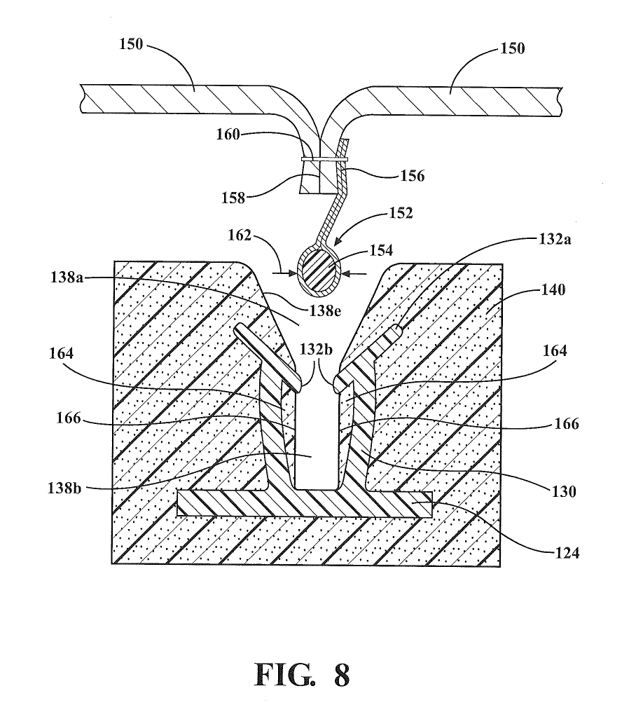

Referring to FIG. 8, a portion of trim cover 150 may typically include two pieces of material joined together at a seam 158. The trim cover 150 may also include an attachment feature 152 connected thereto. The attachment feature 152 includes a rigid cylindrical member 154 enclosed by an attachment cover piece 156. The rigid cylindrical member 154 can be made from a plastic, metal, or other similar rigid material. The rigid cylindrical member 154 is sized to pass between the retaining members 132 of the mechanical clips 122 and may be trapped thereafter, against outward movement therefrom, by the projecting second ends 132b of the retaining members 132 in the trench 138b. The attachment cover piece 156 is retained, via a stitching 160 or other attachment means, against the seam 158 formed in the trim cover 150. Collectively, the diameter of the rigid cylindrical member 154 and attachment cover piece 156 defines an outer diameter 162 that is approximately equal to the width of the narrowed opening 138d and trench 138b. The attachment feature 152 can be constructed of beaded duon, as is commonly known in the art.

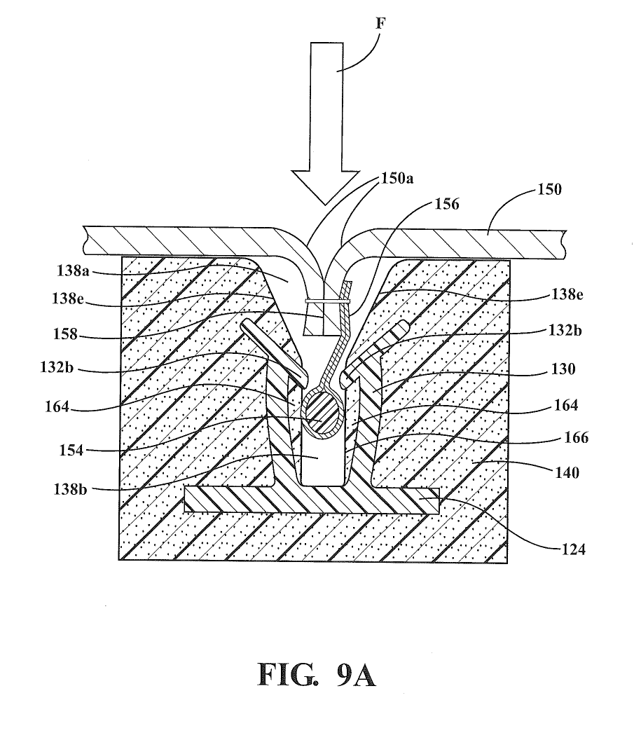

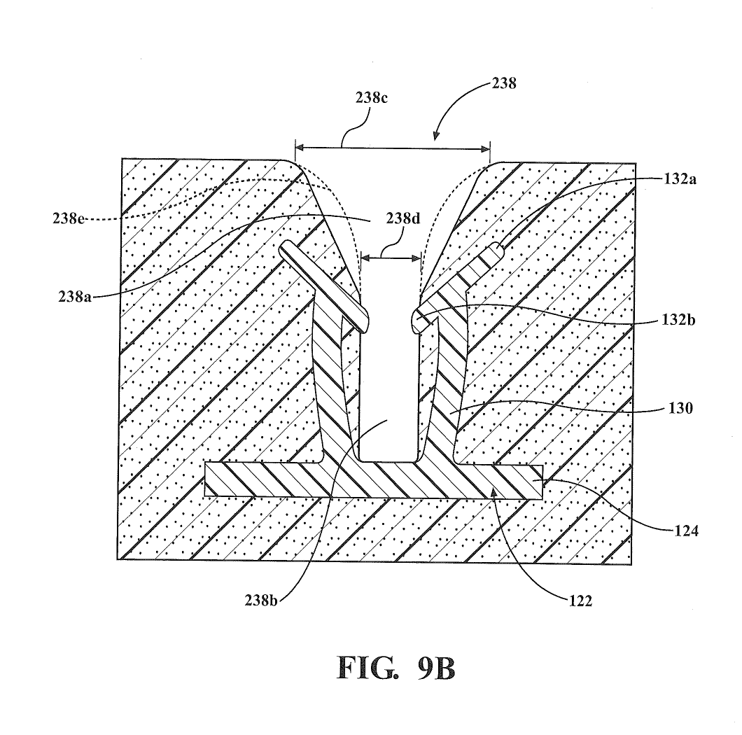

In reference to FIG. 9A, during the process of attaching the trim cover 150 to the foam pad 140, an installer needs only to apply a force F to a top side 150a of the trim cover 150 at the seam 158 or at approximately near a position where the two trim cover pieces 150 are joined together. The force F causes the rigid cylindrical member 154 to move down into the funnel 138a where the side walls 138e guide the rigid cylindrical member 154 therealong and forces the rigid cylindrical member 154 to self-align with the narrowed opening 138d and trench 138b. As a result of the force F, the rigid cylindrical member 154, now being self-aligned, is pressed down between the projecting second ends 132b of the retaining members 132. In response to the rigid cylindrical member 154 being pressed down between the projecting second ends 132b of the retaining members 132, the pressure from the force F imposed thereon triggers the retaining members 132 to spread, thereby allowing the rigid cylindrical member 154 to pass therebetween.

Once the rigid cylindrical member 154 passes fully between the projecting second ends 132b of the retaining members 132, the rigid cylindrical member 154 is guided by a portion 164 of the foam pad 140 that consequently, after the molding process, helps to form side walls 166 of the trench 138b. Side walls 166 of the trench 138b ensure that the rigid cylindrical member 154 self-aligns within the trench 138b, and is mechanically retained therein beneath the projecting second ends 132b of the retaining members 132. While the bases 124 of the mechanical clips 122 are embedded and locked into the foam pad 140 as a result of the molding process, the bases 124 of the mechanical clips 122 are disposed beneath the trench 138b and serves as a bottom of the trench 138b. The length of the attachment cover piece 156 is selected such that once the rigid cylindrical member 154 self-aligns within the trench 138b, and is mechanically retained therein beneath the projecting second ends 132b of the retaining members 132, the trim cover 150 is subsequently pulled taut against the foam pad 140. The funnel 138a provides a space for any trim cover 150 seam salvage to be stored comfortably therein without producing a noticeable and unsightly bulge in the top side 150a of the trim cover 150. The rigid cylindrical member 154 is sufficiently retained against the projecting second ends 132b of the retaining members 132 with there being minimal potential for the rigid cylindrical member 154 to be setback into the trench 138b. Conventional methods typically require an installer to manually guide an attachment feature from the underside of the trim cover in order to engage a corresponding attachment feature located in the foam pad. However, in this manner, the installer guides the self-aligning feature from the top side of the trim cover thereby removing the awkwardness associated with having to maneuver attachment from the underside of the trim cover. Additionally, the requirement for additional tools, aligning and/or adjusting is eliminated.

Regarding FIG. 9B, an alternative exemplary self-aligning clip trench 238 includes a funnel 238a and a trench 238b. The funnel 238a includes a curved taper wherein side walls 238e of the funnel 238 comprises a curved contour which extends from a widened opening 238c to a narrowed opening 238d. The trench 238b is also continuous in length and width, and extends from the narrowed opening 238d of the self-aligning clip trench 238 to the upper surface 126 of the base 124 of the mechanical clip 122. The second ends 132b project into the self-aligning clip trench 238 at about an intersection of the side walls 238e and the narrowed opening 238d wherein the curved orientation of side walls 238e of the funnel 238a and the projecting second end 132b of the retaining member 132, assists in permitting the self-alignment of the trim cover 150.

The method of attaching the trim cover 150 to the foam pad 140 using the self-aligning clip trench 238 of FIG. 9B is similar to the exemplary method for attaching the trim cover 150 to the foam pad 140 using the self-aligning clip trench 138 detailed in FIG. 9A. The exception being that, upon application of the force F, the rigid cylindrical member 154 is guided along the curved side walls 238e wherein the rigid cylindrical member 154 is self-aligned with the narrowed opening 238d and trench 238b. All other molding and installation steps are the same as that detailed for self-aligning clip trench 138.

The invention has been described in an illustrative manner, and it is to be understood that the terminology used is intended to be in the nature of words of description rather than limitation. Many modifications and variations of the present invention are possible in light of the above teachings. It is, therefore, to be understood that within the scope of the appended claims, the invention may be practiced other than as specifically enumerated within the description.

What is claimed:

1. A foam mold rail (100) for use with a foam mold tool in forming a foam pad (140) for a seat, wherein the foam mold rail (100) comprises:
a contoured trench forming section (104), the contoured trench forming section (104) including a funnel shaping segment (108) and a trench segment (110), the trench segment (110) having opposing sides (110a, 110b), a distal tip (116), a plurality of notches (118) and a plurality of slots (120) formed therein;
wherein the foam mold rail (100) is configured to retain a plurality of mechanical clips (122) both vertically and axially with respect to a length of the trench forming section (104) while simultaneously forming a self-aligning clip trench (138, 238) in the foam pad (140) during the foam pad forming process.

2. The foam mold rail (100) as set forth in claim 1 wherein the plurality of notches (118) are formed in the tip (116) of the trench segment (110) and the plurality of slots (120) are formed in the opposing sides (110a, 110b) of the trench segment (110) such that the plurality of slots (120) are spaced beneath the tip (116) of the trench segment (110), respectively, adjacent to the plurality of notches (118).

3. The foam mold rail (100) as set forth in claim 2 wherein the plurality of notches (118) and the plurality of slots (120) comprise respective lengths L2 and L1 and are spaced longitudinally along the length of the trench segment (110).

4. The foam mold rail (100) as set forth in claim 3 wherein the funnel shaping segment (108) includes a widened end (112) and a narrowed end (114), wherein the funnel shaping segment (108) extends from the widened end (112) towards the narrowed end (114).

5. The foam mold rail (100) as set forth in claim 4 wherein the funnel shaping segment (108) tapers linearly from the widened end (112) towards the narrowed end (114).

6. The foam mold rail (100) as set forth in claim 4 wherein the funnel shaping segment (108) curves from the widened end (112) towards the narrowed end (114).

7. A method of mounting a trim cover (150), including an attachment feature (152), to a foam pad (140) of a seat utilizing an attachment device comprising a plurality of mechanical clips (122) including a base (124) and a pair of legs (130) having retaining members (132), the method comprising the steps of:
providing at least one foam mold rail (100) configured to mold the plurality of mechanical clips (122) and form a self-aligning clip trench (138, 238) into the foam pad (140);
molding the foam pad (140) while simultaneously embedding the plurality of mechanical clips (122) and forming the self-aligning clip trench (138, 238);
the step of forming the self-aligning clip trench (138, 238) further includes forming a funnel (138a) and forming a trench (138b) wherein the step of forming the trench (138) involves forming the trench (138) to contain side walls (166) that are formed from a portion (164) of the molded foam pad (140);
securing the trim cover (150) to the foam pad (140); and
mechanically locking the trim cover (150) with respect to the plurality of mechanical clips (122), wherein the mechanically locking step further involves moving the attachment assembly (152) along the funnel (138a) and side walls (166) of the trench (138b) such that the funnel (138a) and side walls (166) provide self-aligning and guiding features for the attachment assembly (152) with the mechanical clips (122).

8. The method of mounting the trim cover (150) to the foam pad (140) as set forth in claim 7, wherein the step of moving the attachment assembly (152) along the funnel (138a) and side walls (166) of the trench (138b) further includes providing a force F to a top surface (150a) of the trim cover (150).

9. The method of mounting the trim cover (150) to the foam pad (140) as set forth in claim 8, wherein the step of molding the foam pad (140) while simultaneously embedding the plurality of mechanical clips (122) and forming the self-aligning clip trench (138, 238) further includes retaining the plurality of mechanical clips (122) both vertically and axially with respect to the foam mold rail (100).

10. The method of mounting the trim cover (150) to the foam pad (140) as set forth in claim 11, wherein the step of retaining the plurality of mechanical clips (122) both vertically and axially with respect to the mold tool (100) further includes:
providing the foam mold rail (100) with a plurality of notches (118) and a plurality of slots (120) wherein the plurality of notches (118), in combination with the plurality of slots (120), assist with retaining the mechanical clips (122).

11. The method of mounting the trim cover (150) to the foam pad (140) as set forth in claim 10, wherein the step of providing the foam mold rail (100) with the plurality of notches (118) and the plurality of slots (120) further includes:
providing the foam mold rail (100) wherein the foam mold rail (100) includes a funnel shaping segment (108) having opposing side walls (110a, 110b) and a trench segment (110) having a tip (116);
forming the plurality of notches (118) in the tip (116) of the trench segment (110) of the mold tool (100);
forming the plurality of slots (120) in the opposing side walls (110a, 110b) of the trench segment (110); and
disposing the plurality of slots (120) such that the plurality of slots (120) are disposed adjacent to and spaced beneath the plurality of notches (118).

12. The method of mounting the trim cover (150) to the foam pad (140) as set forth in claim 11, wherein the step of molding the foam pad (140) while simultaneously embedding the plurality of mechanical clips (122) and forming the self-aligning clip trench (138, 238) further includes positioning the plurality of mechanical clips (122) with respect to the foam mold rail (100) such that the retaining members (132) of the embedded mechanical clips (122) includes a first end (132a) and a second end (132b) wherein the second ends (132b) are exposed and project into the self-aligning clip trench (138, 238).

13. The method of mounting the trim cover (150) to the foam pad (140) as set forth in claim 12, wherein the step of mechanically locking the trim cover (150) with respect to the plurality of mechanical clips (122) further includes engaging the attachment feature (152) with the exposed and projecting second ends (132b) of the retaining members (132) and causing the trim cover (150) to be pulled taut with respect to the foam pad (140).
